(19) United States
(12) Patent Application Publication
(10) Pub. No.: US 2019/0153752 A1
(43) Pub. Date: May 23, 2019

(54) ELECTRONIC LOCK AND RELATIVE OPERATION METHOD

(71) Applicant: GIUSSANI TECHNIQUES S.P.A., 20832 DESIO (MONZA BRIANZA) (IT)

(72) Inventor: MARCO PAGNONCELLI, DESIO (IT)

(21) Appl. No.: 16/097,475

(22) PCT Filed: Apr. 27, 2017
(86) PCT No.: PCT/IB2017/052227

§ 371 Date: Oct. 29, 2018

(30) Foreign Application Priority Data
May 2, 2016 (IT) 102016000044433

(51) Int. Cl. E05B 47/06; E05B 11/02; E05B 47/00; G07C 9/00

(52) U.S. Cl. CPC E05B 47/0626; E05B 11/02; E05B 47/0001; G07C 2009/00873; E05B 2047/0058; E05B 2047/0063; G07C 9/00857

(57) ABSTRACT

A programmable electronic lock (1) comprising at least one electronic key (10) engageable in an electronic lock (1) and configured to allow the opening and/or closing of a shutter (100) by means of too a security code; a containment body (20) which can be mounted on the shutter (100); a block (30), which includes reversible locking/unlocking means (32) able to be electrically actuated and configured to determine a clamping condition or a disengagement condition. The electronic lock (1) comprises reversible locking/unlocking means (32) having a shaped element (32a) rotatable so as to determine, in a first position, a mechanical interference between the block (30) and the containment body (20), so as to prevent a relative movement therebetween, and, in a second position, a condition of no mechanical interference between the block (30) and the containment body (20), so as to allow a relative movement between said block (30) and the containment body (20).

The present invention relates to a programmable electronic lock and the relative operation method.

In particular, the present invention relates to a programmable electronic lock for a shutter or door or similar object and the relative operation method.

Therefore, the present invention relates to a programmable electronic lock that can be used for the safe and easy closing of panels in plants and single-serving food and beverage vending machines, or for closing panels or display stands for which limited and/or conditioned user access is provided, for example through a hierarchical access code.

In the state of the art, electronic locks allow functional use in the face of rather complex structures, both mechanically and electrically/electronically. In particular, electronic locks allow to perform various functions for practical use and safety, so as to satisfy almost every need of the user/customer while being subject to some limitations of use and/or installation.

Electronic locks of the known type are generally not very compact, at least in some mechanical details, therefore they may require a dedicated mounting structure.

In fact, electronic locks of the known type are not predisposed to replace directly a conventional lock, even for the above-mentioned size limits and/or due to incompatibility with the mechanical architecture of the entire shutter, sometimes obsolete and requiring modifications in progress during the installation of the lock itself.

In this context, the technical task underlying the present invention is to propose a programmable electronic lock and relative opening/closing method that overcome the drawbacks and limitation of the known art mentioned above.

In particular, it is an object of the present invention to provide a programmable electronic lock and relative operation method that allow for an easy and quick opening of a shutter or door.

It is another object of the present invention to provide a programmable electronic lock and relative operation method which have a high level of safety, both in the event of a breakdown or forcing of the lock and in the case of managing access credentials for the opening/closing of the same lock according to hierarchical criteria established by the user.

The mentioned technical task and the specified objects are substantially achieved by a programmable electronic lock and relative operation method comprising the technical features set out in one or more of the appended claims.

The dependent claims correspond to possible embodiments of the invention.

Further features and advantages of the present invention will become more apparent from the description of an exemplary, but not exclusive, and therefore non-limiting preferred embodiment of a programmable electronic lock and relative operation method, as illustrated in the appended drawings, wherein:

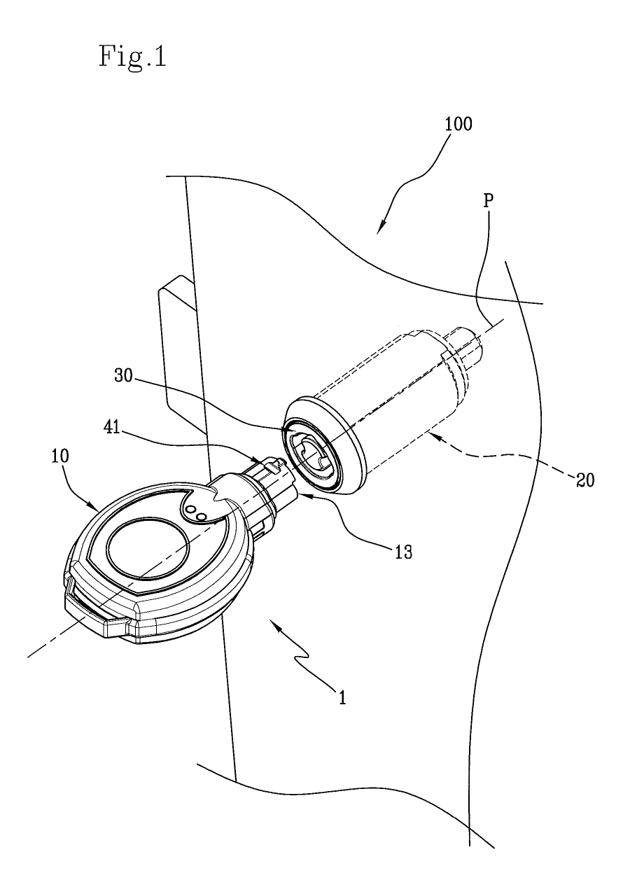

FIG. 1 is a perspective schematic view of the electronic lock and electronic key system according to the present invention;

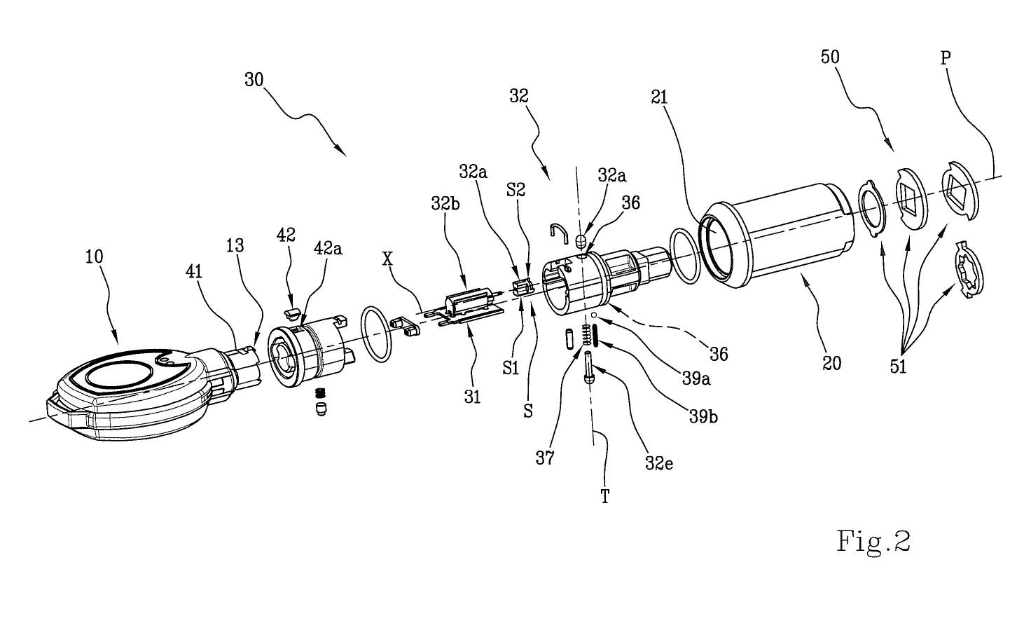

FIG. 2 shows a schematic exploded view of the electronic lock of FIG. 1;

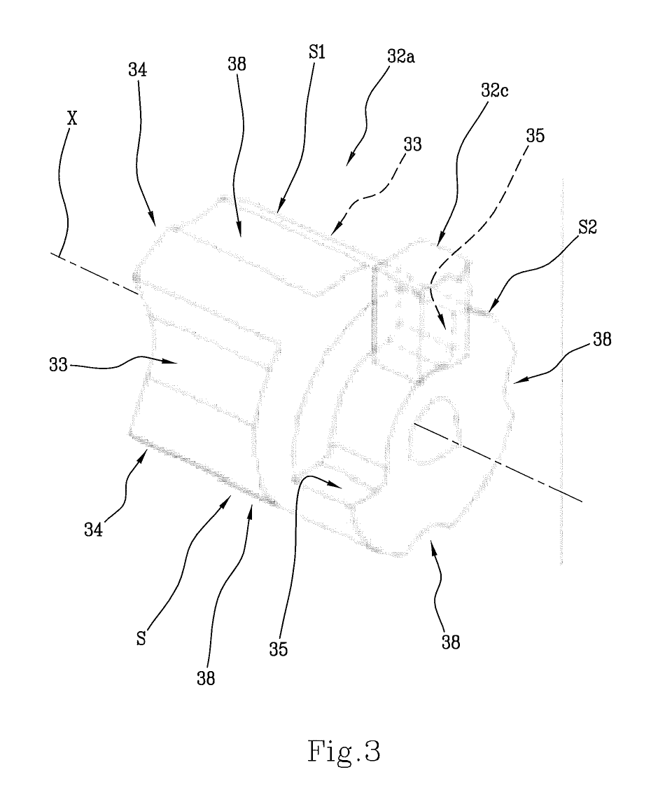

FIG. 3 shows a perspective view of a detail of the system of FIG. 1, with some hidden parts;

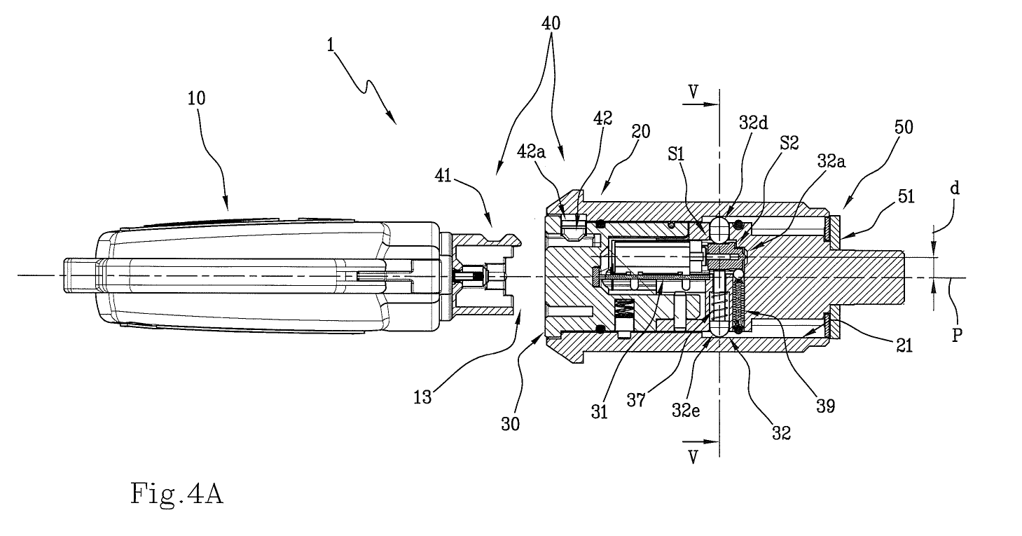

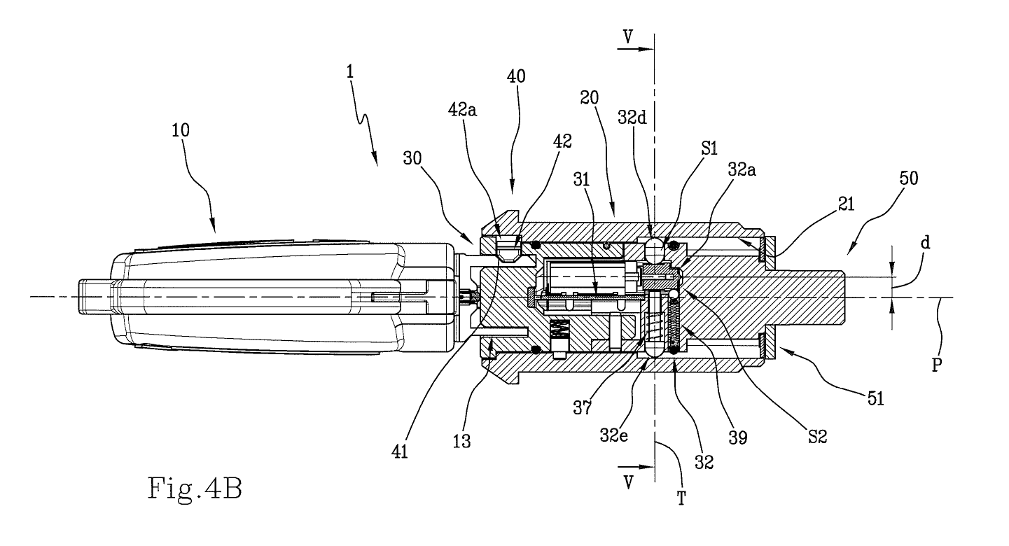

FIG. 4A illustrates a schematic sectional view of the lock and the electronic key of FIG. 1 in a non-coupled configuration;

FIG. 4B shows a schematic sectional view of the lock and the electronic key of FIG. 1 in a coupled configuration;

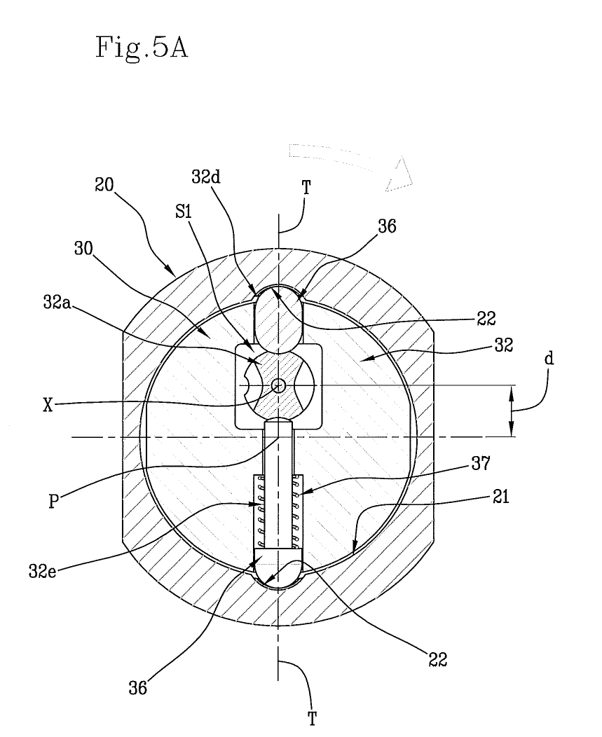

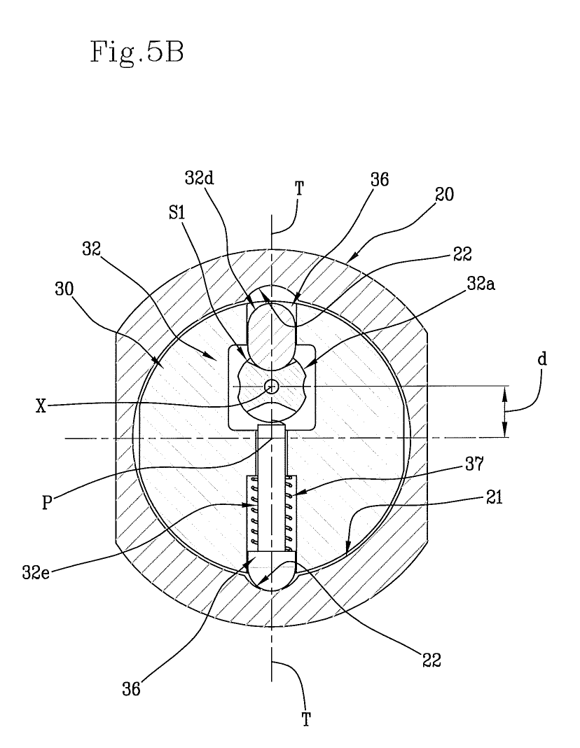

FIG. 5A illustrates a schematic sectional view of the lock of FIG. 4A in an interference condition between a block and a containment body of the lock of FIG. 1, according to the present invention;

FIG. 5B illustrates a schematic sectional view of the lock of FIG. 4B in a non-interference condition between a block and a containment body of the lock of FIG. 1, according to the present invention;

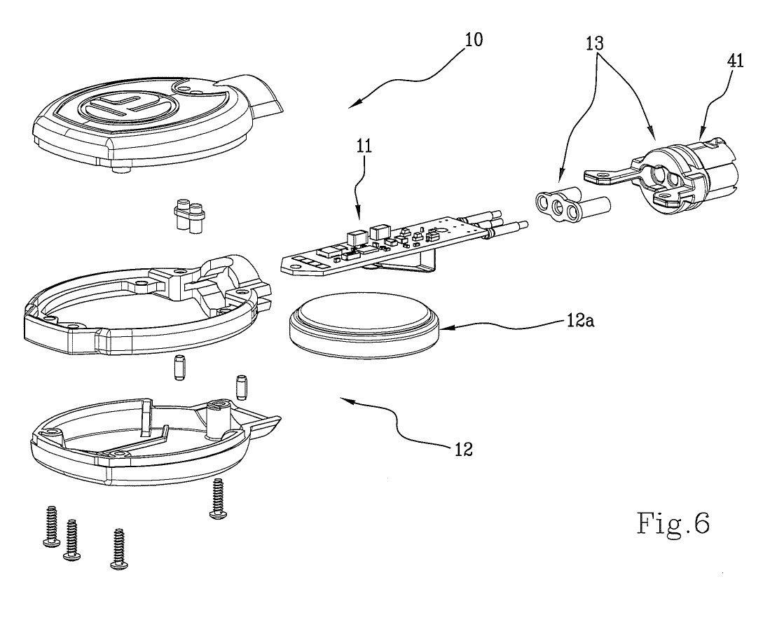

FIG. 6 shows an exploded schematic view of the electronic key of the lock of FIG. 1, according to the present invention;

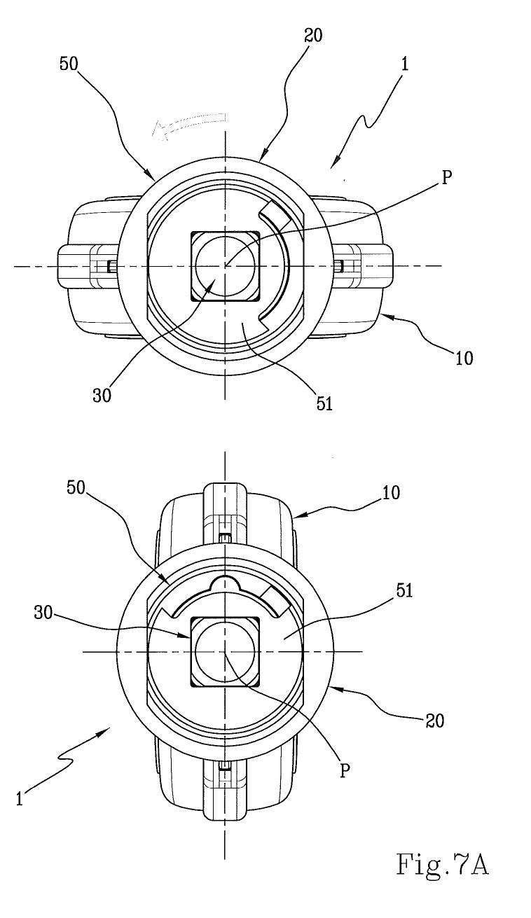

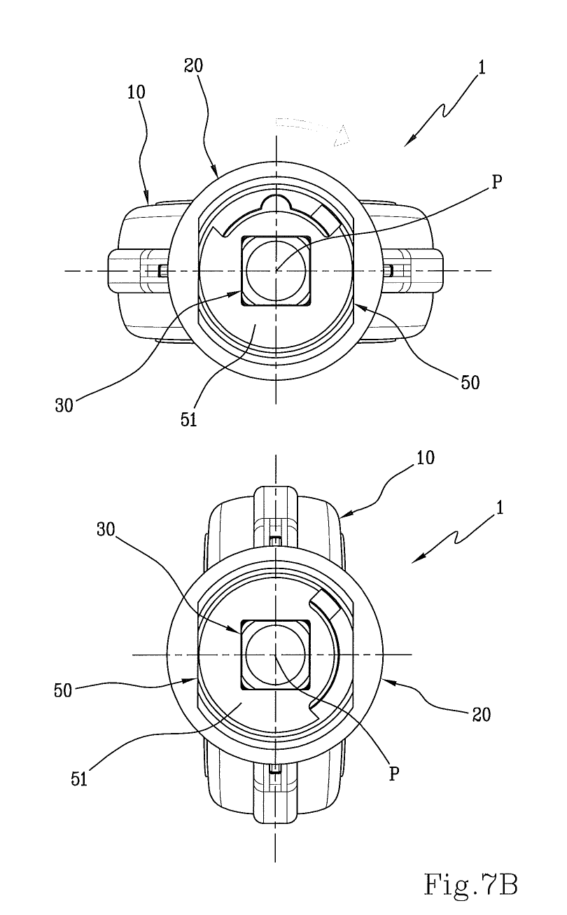

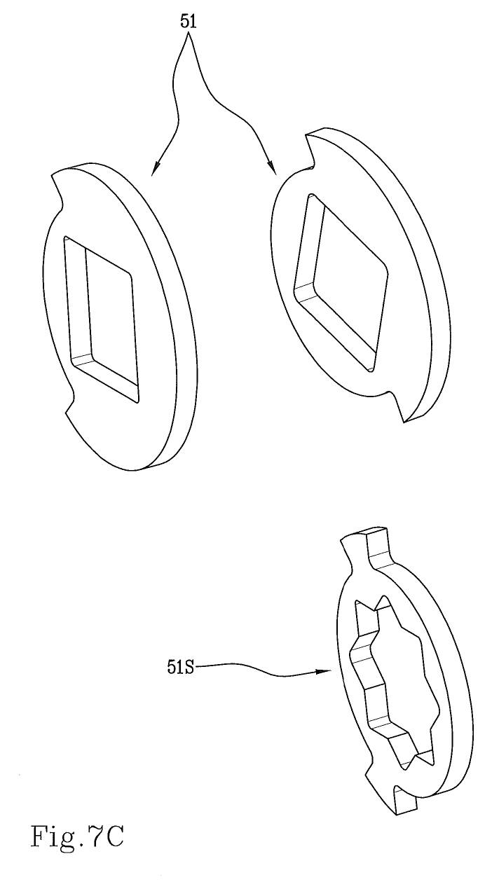

FIG. 7A shows a schematic view of an operation configuration of the lock of FIG. 1;

FIG. 7B shows a schematic view of a different operation configuration of the lock of FIG. 1;

FIG. 7C shows a schematic perspective view of a detail of the lock of FIG. 1, with some hidden parts;

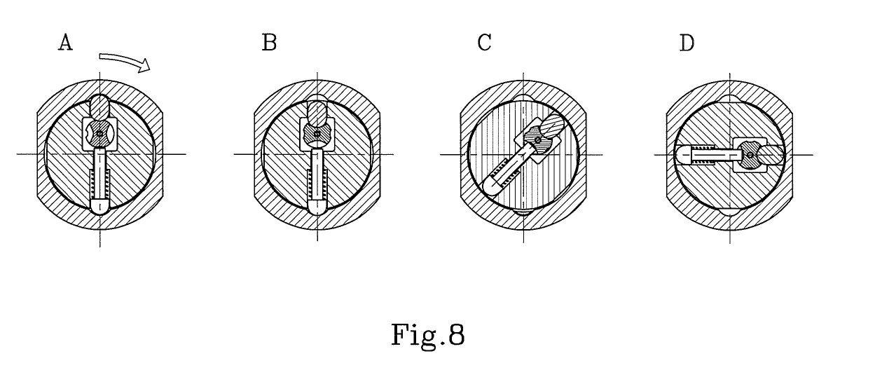

FIG. 8 is a sectional schematic view of the lock of FIG. 1 in an operation configuration according to the present invention;

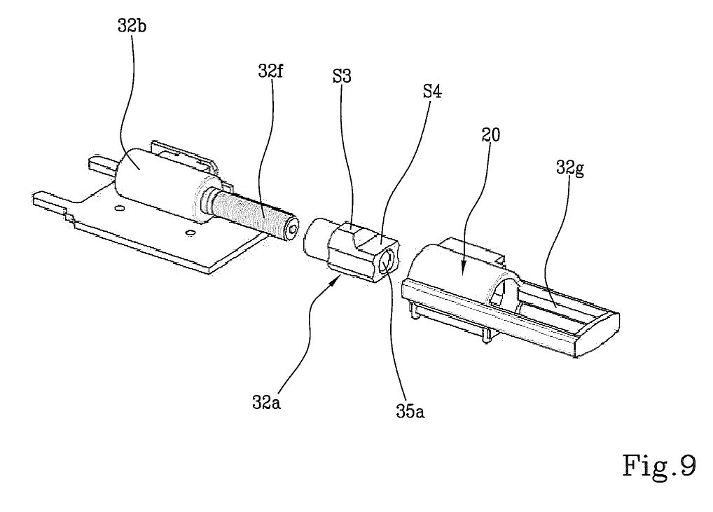

FIG. 9 shows a further possible embodiment of the electronic lock according to the present invention;

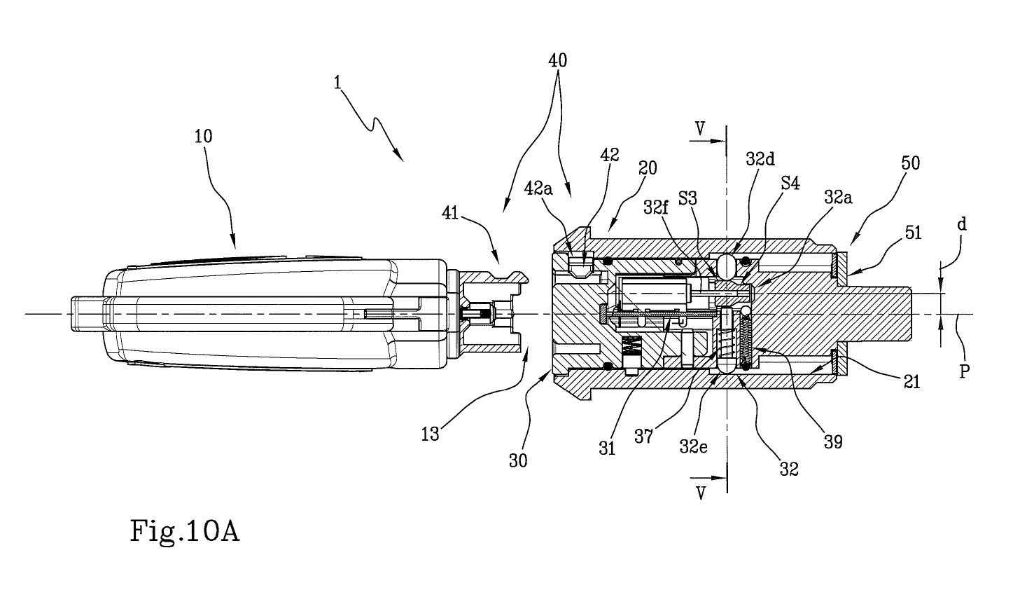

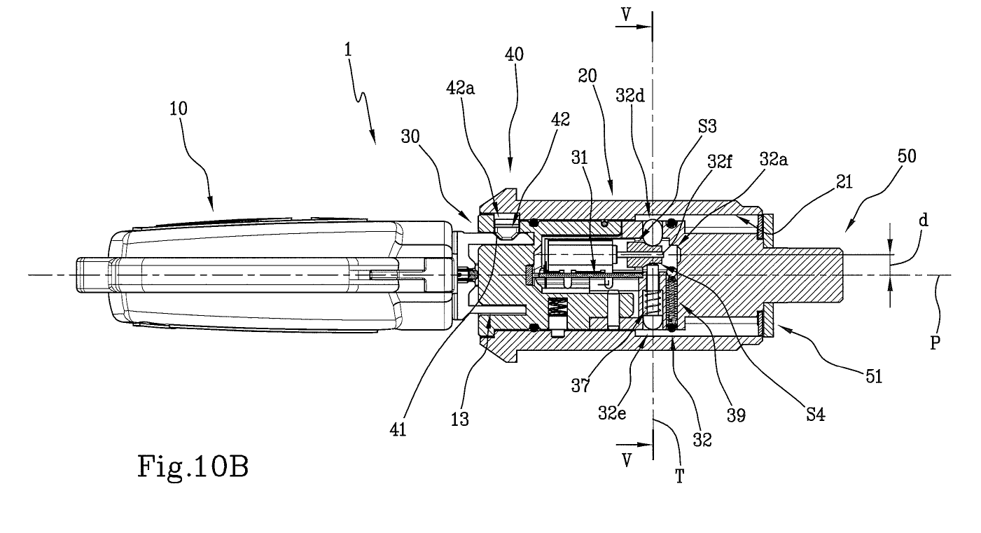

FIG. 10A illustrates a schematic sectional view of the lock and the electronic key of FIG. 9 in a non-coupled configuration;

FIG. 10B shows a schematic sectional view of the lock and the electronic key of FIG. 9 in a coupled configuration;

In accordance with the embodiment of the present invention, the programmable electronic lock is indicated by the reference number 1.

The electronic lock 1 is such that it comprises at least one electronic key 10 engageable in the same programmable electronic lock 1 and configured to allow the opening and/or closing of the shutter 100 or door or similar object by means of a predetermined security code.

In addition, the programmable electronic lock 1 of the present invention includes a containment body 20 and a block 30, operatively housed inside the containment body 20. The containment body 20 and the block 30 constitute the structural part of the electronic lock 1 housed on the shutter 100 while the electronic key 10 is the electronic device adapted to activate the same electronic lock 1 for the opening/closing of the same. Further details about the block 30 and the containment body 20 are provided throughout this description.

The electronic key 10 of the electronic lock 1 comprises at least one electronic storage device 11 configured to store the security code of the key 10 itself.

With reference to the attached FIG. 6, other circuit elements included in the electronic key 10 are illustrated by way of example and without limitation.

More in detail, the electronic key 10 comprises electrical power supply means 12 and an electromechanical connection member 13 configured to establish an electromechanical connection between the electronic key 10 and a part of the electronic lock 1 programmable during an operational condition of use of the electronic lock 1.

In particular, the block 30 is configured to interact directly with the electronic key 10 mentioned above, by virtue of an electromechanical-type connection, in fact it is predisposed at a front end adapted to receive a portion of the electronic key 10 in an operating condition of use of the electronic lock 1.

In particular, the block 30 is configured to be reversibly switched to a clamping condition to prevent the opening of the electronic lock 1 and a disengagement condition to allow the opening of the electronic lock 1.

The block 30 is rotatable with respect to the containment body 20 about its own longitudinal direction of development “P” of the electronic lock 1, or can be translated along the longitudinal development direction “P”, as exemplified in some of the attached figures. Preferably, the longitudinal development direction “P” of the block 30 coincides with the longitudinal development direction of the electronic lock 1.

In particular, the block 30 includes reading and decoding means 31 configured to acquire the security code from the electronic key 10.

Said reading and decoding means 31 are configured to generate a consensus signal to lock and/or unlock the block 30 as a function of a congruity test between a security code pre-stored in the reading and decoding means 31 and the security code of the key 10.

The congruity test of the security code contained in a memory of the key 10 with that pre-stored in the block 30 is one of the main security requirements, and not the only one foreseen for the present invention, to activate the operation of the programmable electronic lock 1.

In terms of security and efficiency of the actuation system, the block 30 of the programmable electronic lock 1 can include reversible locking/unlocking means 32 able to be electrically actuated and configured to determine the clamping condition or the disengagement condition mentioned above. Preferably, the reversible locking/unlocking means 32 are of mechanical type, more preferably the reversible locking/unlocking means 32 are of electro-mechanical type.

In particular, according to a first embodiment, illustrated by way of example in FIGS. 4A and 4B, the reversible locking/unlocking means 32 comprise a shaped element 32a rotatable about its own axis “X”, schematically illustrated in the detail of the appended FIG. 3 during an operational condition of use of the programmable electronic lock 1.

With reference to the appended FIGS. 5A and 5B, the sectional views of the programmable electronic lock 1 are schematically reproduced in two different operating configurations whose sectional “V-V” axes (still visible in the appended FIGS. 4A and 4B) are located at a first surface sector “S1” of the rotatable shaped element 32a.

As mentioned above, the rotatable shaped element 32a is configured to determine in a first position a mechanical interference between the block 30 and the containment body 20 so as to prevent relative movement between them (see the appended FIG. 5A).

The rotatable shaped element 32a is configured to determine in a second position a mechanical non-interference condition between the block 30 and the containment body 20 so as to allow a relative movement between them (see the appended FIG. 5B).

The reversible locking/unlocking means 32 of the block 30 comprise an electric actuator 32b associated with the rotatable shaped element 32a and configured to rotate the shaped element 32a around the axis X.

In accordance with this embodiment, the rotatable shaped element 32a is nested in the structure of the block 30 and is preferably entirely contained therein. Preferably, the maximum size volume of the block 30 includes reading and decoding means 31 and the electric actuator 32b.

The use of the electronic key 10 for the actuation of the programmable electronic lock 1 is the necessary condition for opening a shutter 100 provided with said lock 1.

Specifically, once the electronic key 10 is mechanically engaged in the block 30 of the lock 1, the user merely connects electrically the power supply means 12 at least with the reversible locking/unlocking means 32 of the block 30 itself.

To this end, the electromechanical connection member 13 of the electronic key 10 is configured to establish a mechanical and electrical connection with the reversible locking/unlocking means 32 of the block 30.

It should be noted that the complete mechanical insertion of the electronic key 10 into the block 30 enables the electronic storage device 11 and the electrical power supply means 12 to be placed in electrical connection with the reversible locking/unlocking means 32.

Preferably, the reversible locking/unlocking means 32 are powered by the electrical power supply means 12 of the electronic key 10.

With reference to the appended FIG. 4B, an operating condition of the electronic lock 1 is shown schematically, wherein the electronic key 10 is engaged in the block 30 by establishing a connection condition between the electromechanical connection member 13 and the reversible locking/unlocking means 32, in particular the electric actuator 32b is powered by the electrical power supply means 12 of the electronic key 10. In other words, the electric actuator 32b is powered by the electric power supply means 12 of the electronic key 10 to allow the rotation of the rotatable shaped element 32a from the first mechanical interference position to the second position of no mechanical interference between the block 30 and the containment body 20.

To this end, the power supply means 12 comprise electric storage means 12a as a rechargeable battery (illustrated by way of non-limiting example in the appended FIG. 6), or an accumulator system rechargeable by electromagnetic induction or a recharging system of the piezoelectric type (not shown in the appended figures).

It is to be noted that a disengagement of the electronic key 10 from the block 30 (appended FIG. 4A) entails a power supply interruption to the reversible locking/unlocking means 32, in addition to determining the predetermined condition for activating the closing and locking of the electronic lock 1.

To this end, the energy required to reconfigure the rotatable shaped element 32a from the first to the second mechanical interference position between the block 30 and the containment body 20 can be obtained by means of further electric storage means (not shown in the appended figures) such as to power the electric actuator 32b during rotation of the rotatable shaped element 32a which can be rotated from the second to the first mechanical interference position between the block 30 and the containment body 20.

The further storage means are arranged inside the block 30 and are integral with it, while the electrical power supply means 12 mentioned above are those arranged within the electronic key 10.

Referring to the appended FIG. 3, the rotatable shaped element 32a is illustrated by way of non-limiting example, the peculiar technical features of which are better described below.

The rotatable shaped element 32a has its own axis of rotation “X” parallel to the longitudinal development direction “P” of block 30.

In detail, for example with reference to the appended FIGS. 5A and 5B, the rotation axis “X” of the shaped element 32a is arranged at a predetermined distance “d” from the longitudinal development direction “P” of block 30 and preferably passes through the containment body 20.

Advantageously, the parallelism and the predetermined distance of the axes “X” and “P”, respectively of rotation of the rotatable shaped element 32a and of rotation of the block 30, allow to obtain a compact programmable electronic lock 1, compatible in size with the known closing systems, i.e. that the present electronic lock 1 can be installed in any type of door or shutter which is still equipped with a lock of traditional type, without any modifications to the shutter and/or closing mechanism.

The rotatable shaped element 32a has a cylindrical shape extending along the axis “X” and in which the outer surface “S” of the same and comprises along the axis “X” the first surface sector “S1” mentioned above. The first surface sector “S1” is provided with at least one recess 33 and a domed surface portion 34.

Preferably, the rotatable shaped element 32a also has a second surface sector “S2” adjacent to the first surface sector “S1”.

In particular, the first surface sector “S1” of the rotatable shaped element has two recesses 33 arranged in diametrically opposed positions with respect to the axis “X”.

In addition, the first surface sector “S1” of the rotatable shaped element 32a has two domed surface portions 34 disposed in diametrically opposite positions with respect to the axis “X”.

Preferably, the recesses 33 and the projected surface portions 34 are angularly equidistant to each other of 90 degrees and arranged alternately along the first surface sector “S1”.

The rotatable shaped element 32a has at least one abutment surface 35 at its second surface sector “S2” to determine a travel end abutment of the rotation of the rotatable shaped element 32a from the first position to the second position and vice versa. Preferably, the abutment surfaces 35 are two and are obtained by means of a groove or hole at the second surface sector “S2” of the rotatable shaped element 32a.

The presence of the two abutment surfaces 35 allows to precisely adjust the angular movement of the rotatable shaped element 32a during rotation between the first position and the second position or vice versa.

By way of non-limiting example, the abutment surface 35 and the further abutment surface 35 are schematically shown in FIG. 3 as substantially identically extending surfaces, arranged on two planes perpendicular to each other.

To allow the correct operation of the abutment surfaces 35, the reversible locking/unlocking means 32 comprise at least one locking element 32c integral with the block 30 and operatively associated with the abutment surfaces 35 of the rotatable shaped element 32a. Preferably, the locking element 32c is configured to abut to the abutting surface 35 and to the further abutting surface 35 during rotation between the first position and the second position and vice versa of the rotatable shaped element 32a.

In further detail, as shown for instance in FIGS. 5A and 5B, the reversible locking/unlocking means 32 comprise at least one pin 32d, operatively associated with said rotatable shaped element 32a, configured to engage with its own shaped portion with said first surface area S1 of the rotatable shaped element 32a during the rotation of the latter. In particular, the shaped portion of the pin 32d is that portion to engage with the domed surface portion 34 of the rotatable shaped element 32a when the latter is arranged in the first position (see FIG. 5A) and with the recess 33 of the rotatable shaped element 32a when the latter is arranged in the second position (see FIG. 5B).

Preferably, the reversible locking/unlocking means 32 comprise an additional pin 32e cooperating with pin 32d.

The reversible locking/unlocking means 32 therefore comprise two pins 32d and 32e operatively associated with the rotatable shaped element 32a and configured to engage with its own shaped portion (not specified with reference to, but visible in the attached figures) with the aforementioned portions of the first surface sector “S1”.

Preferably, the pins 32d and 32e are arranged radially with respect to the axis “X” in diametrically opposite positions so as to insist on the surface “S” of the rotatable shaped element 32a, in particular on the recesses 33 and the domed surfaces 34.

The pins 32d and 32e are partially housed inside the block 30 in respective housing cavities 36, as can be seen in the attached figures.

In a radial outermost position with respect to the development and rotation axis “P”, it should be noted that the containment body 20 comprises, on an internal surface 21, at least one seat 22, preferably a seat 22 for each pin 32d and 32e configured to engage with a respective further shaped portion (opposite the aforementioned shaped portion) of the pins 32d and 32e.

Below, only for descriptive convenience, the pin 32d is also referred to as the first pin 32d, and the further pin 32e is also referred to as the second pin 32e.

The pins 32d and 32e have respective trajectories of movement “T” corresponding to the position and orientation of the housing cavities 36 of the block 30. Preferably, the cavities 36 are cylindrical or axial-symmetrical and the pins 32d and 32e have respective trajectories of movement “T” coinciding with the above of the cavities 36.

Preferably, the pins 32d and 32e and the respective sliding cavities 36 are and lying on a single plane “V-V” arranged transversely to the longitudinal direction of development “P”. Preferably, the plane “V-V” is perpendicular to the longitudinal direction of development “P”.

Preferably, the trajectories of movement “T” of the pins 32d and 32e are arranged in diametrically opposed positions with respect to the “X” axis, even more preferably the trajectories of movement “T” of the pins 32d and 32e are perpendicular to the rotation axis “X” of the rotatable shaped element 32a.

In accordance with the preferred embodiment of the present invention, the pins 32d and 32e have respective lengths “L1” and “L2” such that they preferably differ from the predetermined distance “d” between the axis of rotation “X” of the shaped element 32a and the longitudinal development direction “P” of the block 30.

The predetermined difference in length between the two pins 32d and 32e allows to reduce the size of at least one of them and therefore also to reduce the mass and mechanical features to a predetermined configuration, optimizing the overall size of the containment body 20 and of the electronic lock 1 in general.

Preferably, the first pin 32d is the selected pin with a shorter length “L1” and the second pivot 32e is the pivot having a longer length equal to “L2”.

The first pin 32d is movable along the respective trajectory of movement “T” due to gravity force, so there is no need for other systems to implement its movement along the trajectory “T” itself.

The appended FIGS. 5A and 5B show by way of example, the first pin 32d having a reduced movable mass along the respective cavity 36 between the first position and the second position of the reversible locking/unlocking means 32: the displacement of the first pin 32d occurs by “gravitational fall” once the rotatable shaped element 32a is placed in the second position.

The second pin 32e is preferably moved by an elastic element 37 such that it is normally held in an engaging position with the seat 22 on the inner surface 21 of the containment body 20 (first position of the reversible locking/unlocking means 32).

The second pin 32e is configured to be inserted/disengaged from the seat 22 of the containment body 20 by means of a shaped end to facilitate clamping and especially removal during the rotation of the block 30 for opening/closing the electronic lock 1.

Referring now to the appended FIG. 3, it shows, by way of non-limiting example, a plurality of niches 38 arranged in correspondence with the outer surface “S” of the rotatable shaped member 32a, arranged in particular at the first surface sector “S1” and partially at the second surface sector “S2”. Preferably, the niches 38 are such that they extend along the axis of rotation “X” of the rotatable shaped element 32a from the first surface sector “S1” to the second surface sector “S2”.

In particular, at the first surface sector “S1” there are two diametrically opposed niches 38 formed on the domed surface portions 34 of the rotatable shaped element 32a.

The two niches 38 mentioned above are configured to interact in particular with the first pin 32d and second pin 32e, as illustrated, for example, in the appended FIGS. 5A and 5B.

Advantageously, the niches 38 obtained on the rotatable shaped element 32a at the first surface area “S1” have the function of eliminating any gap or vibration between the pins 32d, 32e, the block 30 and the rotatable shaped element 32a and the same especially when the latter is placed in the first (locking) position of the electronic lock 1.

Advantageously, the complete elimination of gaps/vibrations with the system described above provides a very silent and precise electronic lock 1, in addition to giving the user a feeling of high strength and quality of the lock 1 itself.

In detail, at the second surface area “S2” there are preferably two niches 38, angularly spaced apart from each other by 90 degrees, which are formed on a full portion of the rotatable shaped element 32a where there are no recesses and/or abutting surfaces 35. Preferably, at least a niche 38 is the extension along “X” of one of the niches 38 present in the first surface sector “S1”.

Preferably, the further niches 38 are configured to interact with respective retention means 39 during rotation of the rotatable shaped element 32a between the first position and the second position and vice versa.

In particular, the retention means 39 comprise a ball 39a and an elastic member 39b, such as a cylindrical helical spring, configured to push the ball 39a towards the rotatable shaped element 32a so as to allow the ball 39a to be inserted into one of the further niches 38 when the ball 39a and niche 38 are in correspondence with one another, for example in a first position or a second position. Preferably, the niches 38 are configured to function only when the rotatable shaped element 32a is positioned in the first or in the second operation position.

Advantageously, the further niches 38 formed on the rotatable shaped element 32a at the second surface sector “S2” have the function of eliminating any gaps and/or vibrations of the rotatable shaped element 32a, as described above.

In accordance with the present invention, the programmable electronic lock 1 comprises a selective retention mechanism 40 of the electronic key 10 configured to retain the electronic key 10 in the block 30 when the angular position of both of them does not correspond to a predetermined closing position of the electronic lock 1.

Referring to FIGS. 4A and 4B, they show schematically, by way of non-limiting example, some details of the selective retention mechanism 40.

The selective retention mechanism 40 is configured so as to allow the safe removal of the electronic key 10 from the block 30 when both are in the predetermined angular position for closing the electronic lock 1. In other words, the user by means of the selective retention mechanism 40 cannot inadvertently extract the electronic key 10 from the block 30 except when it is in the predetermined position of locking the lock 1 itself.

In particular, the selective retention mechanism 40 of the electronic key 10 comprises a recess 41 made on a portion of the electromechanical connection member 13 of the electronic key 10 and a respective movable plug 42 disposed on said block 30 and inserted in the recess 41 in a condition of the key 10 inserted in the block 30.

The movable plug 42 is configured to move along its housing seat 42a formed on the block 30 to allow insertion/disengagement towards and of the recess 41 when the block 30 is in an angular position compatible with an opening of the lock 1.

The movable plug 42 is configured to be lockable in the position inserted inside the recess 41 of the electronic key 10 when the block 30 is in an angular position incompatible with an opening of the lock 1.

According to the present invention, the programmable electronic lock 1 comprises an angular selection system 50 of the rotation of the block 30 which comprises a plurality of washers 51 which can be inserted during the installation of the electronic lock 1 on the shutter 100 between the block 30 and the containment element 20 to determine the maximum angular rotation of the block 30 and/or the predetermined rotation direction for the opening/closing of the electronic lock 1 itself. In other words, the coupling of the washers 51 allows to determine the rotational excursion of the electronic key 10 (and of the block 30) when inserted into the block 30 and the rotation direction thereof in accordance with the usage preferences established prior to assembly of the lock 1 by the user and/or for structural reasons of the closing of the shutter 100.

Preferably, the angular selection system 50 comprises two shaped washers 51 which can be arranged mutually on one side or the opposite side so as to determine at least four combinations between angular excursion and rotation direction of the block 30.

FIG. 7A illustrates the electronic lock 1 in a switching sequence from the first position to the second position with the arrangement of the angular selection system 50 to allow the opening to rotate by 90° to the right as indicated by the arrow (clockwise rotation seen from the side of the key 10).

FIG. 7B illustrates the electronic lock 1 in a switching sequence from the first position to the second position with the arrangement of the angular selection system 50 to allow the opening to rotate by 90° to the left as indicated by the arrow (counterclockwise rotation seen from the side of the key 10).

An example of possible washers 51 of the angular selection system 50 is shown in the appended FIG. 7C.

Alternatively, the angular selection system 50 of the rotation of block 30 of the electronic lock 1 comprises a single shaped washer 51s configured to determine at least four combinations between angular excursion and direction of rotation of the block 30 as illustrated by way of non-limiting example in the appended FIG. 7C.

According to the present invention, the reversible locking/unlocking means 32 of the block 30 comprise a primary electronic storage device (not shown in the appended figures) configured to store a plurality of security codes of a respective plurality of electronic keys 10 engageable in the above-described programmable electronic lock 1.

In particular, the programmable electronic lock 1 comprises an electronic programming key (not shown in the appended figures) configured to transfer to the primary storage device mentioned above the plurality of security codes to be stored to allow a use of the electronic lock 1 subject to, for example, a hierarchical relevance of the user.

Preferably, according to the invention, the electronic programming key and the electronic keys 10 engageable in the programmable electronic lock 1 can be reprogrammed each time it is needed by means of a key reading/writing device, not shown in the appended figures. For example, the key reading/writing device is a POD for housing key, master/slave, for programming security codes.

Preferably, the electronic programming key is configured to replace, modify or cancel the plurality of security codes stored on said primary electronic storage device of the reversible locking/unlocking means 32 of the block 30 and/or on the electronic storage device 11 of the electronic keys 10 engageable in the programmable electronic lock 1.

In accordance with a further possible embodiment, shown in FIGS. 10A and 10B, the reversible locking/unlocking means 32 are realized by means of an internally threaded shaped element 32a configured to slide, by means of a screwing/unscrewing movement, along a threaded pin 32f preferably coaxial with the longitudinal development direction “P” of the electronic lock 1 itself.

In this case, the electric actuator 32b associated with the shaped element 32a is configured to propagate the shaped element 32a along its axis X.

In other words, the activation of the electric actuator causes the threaded pin 32f to rotate, causing the unscrewing or screwing, along the pin 32f itself, of the shaped element 32a that is then made to translate along the axis “X” allowing the reversible locking/unlocking means 32 to be brought into the clamping or disengagement condition.

In order to ensure that the shaped element performs a purely translational motion and is not affected by a rotating motion, the containment cage 20 comprises anti-rotational means 32g, which are able to constrain the shaped element to slide along the axis “X” without rotating.

According to a preferred embodiment, shown in the accompanying drawings for explanatory and non-limiting purposes, the anti-rotational means 32g are realized in the form of linear guides, adapted to engage a surface portion of the shaped element 32a by sliding it along the guides themselves.

In other words, the rotation of the threaded pin 32f naturally tends to rotate also the shaped element 32 to which it is screwed; however, the presence of the guides (32g) prevents the rotation of the shaped element 32a, causing it to be screwed/unscrewed depending on the direction of rotation of the threaded pin 32f, and hence on the translation along the axis X.

According to this particular embodiment, the shaped element 32a has a cylindrical shape extending predominantly along the “X” axis and whose outer surface “S” comprises a surface clamping sector “S3” and a surface disengagement sector “S4”.

In particular, the surface disengagement sector “S4” includes an end surface 35a which determines a travel end stop of the translation of the shaped element 32a when the latter is moved.

In addition, the reversible locking/unlocking means comprise at least one pin 32d operatively associated to the shaped element 32a.

The pin 32d is configured to engage its own shaped portion with the surface clamping sector “S3” of the shaped element 32a in the first position and the disengagement surface sector “S4” in the second position.

In other words, as can be seen in more detail in the accompanying FIGS. 10A and 10B, the pin 32d can engage the surface clamping portion “S3”, causing a clamping condition of the block (30), or the surface disengagement portion “S4”, causing a disengagement condition of the block (30).

The reversible locking/unlocking means 32 further comprise a seat 22 made in an inner surface 21 of the containment body 20. The seat 22 is configured to engage with a respective further shaped portion of the pin 32d in an operating condition of use of the electronic lock 1.

The reversible locking/unlocking means 32 further comprise two pins 32d, 32e operatively associated with the shaped element 32a and configured to engage their own shaped portion with the surface clamping and disengagement sectors “S3”, “S4” of the shaped element 32a during the translation of the latter.

The pins 32d, 32e are preferably disposed in diametrically opposite positions with respect to the axis “X” and partially housed inside the block 30 in respective housing cavities 36.

According to this possible embodiment, the electric actuator 32b associated with the shaped element 32a is configured to rotate the threaded pin 32f around the axis “X”, being supplied by the electrical power supply means 12 of the electronic key 10.

Preferably, the electric actuator is powered when the electronic key 10 is engaged in the programmable electronic lock 1, determining that the electromechanical connection member 13 is connected to the reversible locking/unlocking means 32 of the lock 1 itself.

In particular, the electric actuator 32b is powered by the electric power supply means 12 of the electronic key 10 during rotation of the rotatable threaded pin 32f, causing the switching of the translatable shaped element 32a from the first position to the second position.

Further, the reversible locking/unlocking means 32 comprise electrical storage means such as to feed the electric actuator 32b during rotation of the threaded pin 32f by switching the translatable shaped element 32a from the second position to the first position.

In accordance with the inventive concept of the present invention, described below is a method of opening the programmable electronic lock 1 as described above. By way of illustration and without limitation, the opening sequence of the electronic lock 1 is illustrated in FIG. 8, which shows the sequence A-D of opening of the electronic lock 1 in accordance with the present invention. In detail, FIG. 8 from A to B shows the phase of rotation from the first position to the second position of the shaped element 32a and subsequently, from C to D, the rotation phase of the inner block 30 (containing the reversible locking/unlocking means 32) for opening the shutter 100.

Specifically, the main steps of the opening sequence of the electronic lock 1 include:
providing an electronic lock 1 as described above by installing it on a shutter 100 or a door or similar object; optionally
pre-programming an electronic key 10 by means of a key reading/writing device;
insert the pre-programmed electronic key 10 in the electronic lock 1 so as to connect the electronic storage device 11 and said electrical power supply means 12 of the electronic key 10 with the reversible locking/unlocking means 32 present in the block 30, while the selective retention mechanism 40 of the electronic key 10 is switched to an electronic key configuration 10 inserted in the block 30;
waiting for an attention acoustic and/or luminous signal or other signal type emitted by said electronic key 10 to signal to a user that a conversion has occurred from the first mechanical interference position (position A of FIG. 8) to the second position of no mechanical interference (position B of FIG. 8) between the lock 30 and the containment element 20;
rotating in one direction and by a predetermined angle the electronic key 10 (positions C and D of FIG. 8), which is mechanically/electrically inserted/connected with the block 30 of the electronic lock 1 to open the lock 1 itself by moving a closing latch.

In accordance with the inventive concept of the present invention, described below is a method of closing the programmable electronic lock 1 as described above. A method of closing the electronic lock 1 described above, comprising the steps of:
moving the shutter 100 or a door or object similar towards the respective abutment frame (not shown in the attached figures) to close the shutter 100;
rotating in a direction opposite to the opening direction and for a given angle the electronic key 10, which is still mechanically/electrically inserted/connected with the block of the electronic lock 1;
extracting said electronic key 10 from the block 30 of the lock 1, while the selective retaining mechanism 40 of the electronic key 10 is switched to a configuration wherein the electronic key 10 is not inserted in the block 30;
waiting for an attention acoustic and/or luminous signal or other signal type emitted by said electronic key 10 to signal to a user that the conversion has occurred from the second position of no mechanical interference to the first mechanical interference position between the lock 30 and the containment element 20.

The present invention has achieved the intended purposes.

Advantageously, the present invention provides an extremely compact programmable electronic lock and is suitable for replacing all traditional locks of shutters, panels, doors and the like.

Advantageously, the present invention provides a silent programmable electronic lock, mechanically safe against any infraction.

Advantageously, the present invention provides a programmable electronic lock that allows hierarchical or conditioned use of accesses by programming a wide range of security codes.

Advantageously, the synergistic effect of the technical solutions described above makes it possible to provide a programmable electronic lock 1 in accordance with the present invention having high precision, greater than known electronic locks, and such that it gives the user a feeling of high robustness and quality.

1. Programmable electronic lock (1) for a shutter (100) or a door or similar object, comprising:
at least one electronic key (10) engageable in said programmable electronic lock (1) and configured to allow the opening and/or closing of said shutter (100) or door or similar object by means of a security code;
a containment body (20) installable on said shutter (100) or door or similar object;
a block (30) operatively housed within said containment body (20) and configured to be reversibly switchable in a clamping condition, in which it prevents an opening of said shutter (100) or door or similar object, and a disengaging condition, in which it allows said opening of said shutter (100) or door or similar object;
wherein said block (30) comprises reading and decoding means (31) configured to acquire said security code from said electronic key (10), and wherein said reading and decoding means (31) are configured to generate an enabling signal to block and/or release said block (30) as a function of a congruency check between a pre-stored security code and said security code of said key (10);
wherein said block (30) comprises reversible locking/unlocking means (32) such as to be actuated electrically and configured to determine said clamping condition or said disengaging condition, said reversible locking/unlocking means (32) comprising a shaped element (32a) rotatable about or translatable along a respective axis (X) so as to determine, in a first position, a mechanical interference between said block (30) and said containment body (20), so as to prevent a relative movement therebetween, and, in a second position, a condition of no mechanical interference between said block (30) and said containment body (20), so as to allow a relative movement between said block (30) and said containment body (20);
wherein said electronic key (10) comprises at least one electronic storage device (11) configured to store said security code of said key (10), electrical power supply means (12) and an electromechanical connection member (13) configured to establish a connection of the mechanical and electrical type with said reversible locking/unlocking means (32), so as to mechanically engage said electronic key (10) with said block (30) and to electrically connect said electrical power supply means (12) with at least said reversible locking/unlocking means (32), in an operative condition of use of said programmable electronic lock (1);
characterized in that it comprises an angular selection system (50) for the rotation of the block (30) of the electronic lock (1), wherein said angular selection system (50) comprises a plurality of washers (51) insertable between said block (30) and said containment element (20) so as to determine the maximum angular excursion for the rotation of the block (30) and/or the predetermined rotation direction for the opening/closing of the electronic lock (1) itself, preferably said angular selection system (50) comprising two shaped washers (51) positionable alongside each other on one side or on opposite sides so as to determine at least four combinations between angular excursion and rotation direction of the electronic lock (1).

2. Lock (1) according to claim 1, wherein said reversible locking/unlocking means (32) of said block (30) comprising a primary electronic storage device configured to store a plurality of security codes of a respective plurality of electronic keys (10) engageable in said programmable electronic lock (1).

3. Lock (1) according to claim 1 or 2, comprising a selective retaining mechanism (40) of said electronic key (10) configured to hold the electronic key (10) in the block (30) when the angular position of both does not correspond to a predetermined closure position of the electronic lock (1), and wherein said selective retaining mechanism (40) is configured so as to allow the extraction of the electronic key (10) from the block (30) when they both are in the predetermined angular position for closing said electronic lock (1).

4. Lock (1) according to claim 3, wherein said selective retaining mechanism (40) of said electronic key (10) comprises a recess (41) formed on a portion of said electromechanical connection member (13) of the electronic key (10) and a respective movable plug (42) arranged on said block (30) and insertable in said recess (41) in a condition of key (10) inserted in the block (30), said movable plug (42) being translatable along its own housing seat (42a) formed on the block (30) to allow a connection/disconnection from said recess (41) when said block (30) is in an angular position compatible with an opening of the electronic lock (1), said movable plug (42) being lockable in the inserted position within said recess (41) of the electronic key (10) when said block (30) is in an angular position not compatible with an opening of the electronic lock (1).

5. Lock (1) according to claim 1, wherein said angular selection system (50) for the rotation of the block (30) of the electronic lock (1) comprises a single shaped washer (51s) configured to determine at least four combinations between angular excursion and rotation direction.

6. Lock (1) according to claim 1, wherein said rotatable shaped element (32a) has its own rotation axis (X) parallel to one longitudinal development direction (P) of said block (30), said rotation axis (X) of said rotatable shaped element (32a) being arranged at a distance (d) predetermined by said longitudinal development direction (P) of the block (30) and passing through the containment body (20), preferably said longitudinal development direction (P) being the rotation axis of said block (30) with respect to said containment body (20).

7. Lock (1) according to claim 1, wherein said rotatable shaped element (32a) has a cylindrical shape extending along said axis (X), and wherein the outer surface (S) of said rotatable shaped element comprises, along the axis (X), a first surface area (S1) having at least one recess (33) and a domed surface portion (34) and a second surface area (S2), adjacent to the first surface area (S1), having at least one abutment surface (35) to determine a abutment stop of the rotation of said rotatable shaped element (32a) from said first position to said second position, and vice versa.

8. Lock (1) according to claim 7, wherein said reversible locking/unlocking means (32) comprise at least one locking element (32c) integral with said block (30) and operatively associated with said rotatable shaped element (32a), wherein said locking element (32c) is configured to abut said at least one abutment surface (35) of said second surface area (S2) of the rotatable shaped element (32a) during the rotation of the latter.

9. Lock (1) according to claim 7, wherein said reversible locking/unlocking means (32) comprise at least one pin (32d) operatively associated with said rotatable shaped element (32a), and wherein said pin (32d) is configured to engage with its own shaped portion with said first surface area (S1) of the rotatable shaped element (32a) during the rotation of the latter.

10. Lock (1) according to claim 9, wherein said reversible locking/unlocking means (32) comprise at least a seat (22) on an inner surface (21) of said containment body (20), and configured to engage with a respective further shaped portion of said pin (32d) in an operative condition of use of said electronic lock (1).

11. Lock (1) according to claim 9, wherein said pin (32d) is configured in such a way that said shaped portion of the pin (32d) is such as to engage with said domed surface portion (34) of the rotatable shaped element (32a) in the first position and with said recess (33) of the rotatable shaped element (32a) in the second position.

12. Lock (1) according to claim 7, wherein said first surface area (S1) of the rotatable shaped element (32a) has two recesses (33) arranged in diametrically opposite positions with respect to said axis (X) and two domed surface portions (34) arranged in diametrically opposite positions with respect to said axis (X), said recesses (33) and said domed surface portions (34) being angularly equidistant from each other by 90 degrees, and arranged in alternate way along said first surface area (S1).

13. Lock (1) according to claim 8, wherein said reversible locking/unlocking means (32) comprise two pins (32d, 32e) operatively associated with said rotatable shaped element (32a), and configured to engage with an own shaped portion with said first surface area (S1) of the rotatable shaped element (32a) during the rotation of the latter, said pins (32d, 32e) being arranged in diametrically opposite positions with respect to said axis (X) and partially housed inside of said block (30) in respective housing cavities (36).

14. Lock (1) according to claim 1, wherein reversible locking/unlocking means (32) of the block (30) comprise an electric actuator (32b) associated with said rotatable shaped element (32a) and configured for rotating about said axis (X) the rotatable shaped element (32a) itself, wherein said electric actuator (32b) is powered by said electrical power supply means (12) of the electronic key (10) preferably when the electronic key (10) is engaged in the programmable electronic lock (1) by determining that the electromechanical connection member (13) is connected to the reversible locking/unlocking means (32) of the lock (1) itself.

15. Lock (1) according to claim 14, wherein said electric actuator (32b) is powered by said electrical power supply means (12) of the electronic key (10) during the rotation of the rotatable shaped element (32a) from said first position to said second position, and wherein said reversible locking/unlocking means (32) comprise electric storage means such as to power said electric actuator (32b) during the rotation of the rotatable shaped element (32a) from the second position to the first position.

16. Lock (1) according to claim 1, wherein said translatable shaped element (32a) has its own translation axis (X) parallel to one longitudinal development direction (P) of said block (30), said translation axis (X) of said translatable shaped element (32a) being arranged at a distance (d) predetermined by said longitudinal development direction (P) of the block (30) and passing through the containment body (20), preferably said longitudinal development direction (P) being the translation axis of said block (30) with respect to said containment body (20).

17. Lock (1) according to claim 16, wherein said reversible locking/unlocking means (32) comprise a threaded pin (32f), preferably coaxial to the longitudinal development direction (P), adapted to mediate the translation of the translatable shaped element (32a) by a screwing/unscrewing movement of the shaped element (32a) which can be moved along said threaded pin (32f).

18. Lock (1) according to claim 16 or 17, wherein the containment body (20) comprises at least one guide (32g) associated with the shaped element (32a) which is movable and configured to prevent rotation of the shaped element (32) about the translation axis (X).

19. Lock (1) according to claim 16, wherein said translatable shaped element (32a) has a cylindrical shape extending along said axis (X), and wherein the outer surface (S) of said translatable shaped element comprises, along the axis (X), a surface clamping sector (S3) having and a surface disengagement sector (S4) adjacent to the surface clamping sector (S3) having at least an travel end surface (35a) to determine a travel end abutment stop of the translation of said shaped element (32a) translatable from said first position to said second position and vice versa.

20. Lock (1) according to claim 19, wherein said reversible locking/unlocking means (32) comprise at least one pin (32d) operatively associated with said translatable shaped element (32a), and wherein said pin (32d) is configured to engage with its own shaped portion with said surface clamping sector (S3) of the translatable shaped element (32a) in the first position and wherein said pin (32d) is configured to engage with its shaped portion said surface disengagement sector (S4) of the shaped element (32a) translatable in the second position.

21. Lock (1) according to claim 20, wherein said reversible locking/unlocking means (32) comprise at least a seat (22) on an inner surface (21) of said containment body (20), and configured to engage with a respective further shaped portion of said pin (32d) in an operative condition of use of said electronic lock (1).

22. Lock (1) according to claim 20, wherein said pin (32d) is configured in such a way that said shaped portion of the pin (32d) is such as to engage with said surface clamping position (S3) of the translatable shaped element (32a) in the first position and with said surface disengagement portion (S4) of the translatable shaped element (32a) which can be translated in the second position.

23. Lock (1) according to claim 20, wherein said reversible locking/unlocking means (32) comprise two pins (32d, 32e) operatively associated with said translatable shaped element (32a) and configured to engage by its own shaped portion with said surface clamping and disengagement sectors (S3, S4) of the translatable shaped element (32a) which can be translated during the translation of the latter, said pins (32d, 32e) being arranged in diametrically opposed positions to said axis (X) and partially housed within said block (30) in respective housing cavities (36).

24. Lock (1) according to claim 16, wherein reversible locking/unlocking means (32) of the block (30) comprise an electric actuator (32b) associated with said translatable shaped element (32a) and configured for rotating about said axis (X) the threaded pin (32f), wherein said electric actuator (32b) is powered by said electrical power supply means (12) of the electronic key (10) preferably when the electronic key (10) is engaged in the programmable electronic lock (1) by determining that the electromechanical connection member (13) is connected to the reversible locking/unlocking means (32) of the lock (1) itself.

25. Lock (1) according to claim 24, wherein said electric actuator (32b) is powered by said electrical power supply means (12) of the electronic key (10) during the rotation of the rotatable threaded pin (32f) causing the switching of said translatable shaped element (32a) which can be translated from said first position to said second position, and wherein said reversible locking/unlocking means (32) comprise electric storage means such as to power said electric actuator (32b) during the rotation of the threaded pin (32f) switching the translatable shaped element (32a) from the second position to the first position.

26. Lock (1) according to claim 13, wherein said pins (32d, 32e) have respective trajectories of movement (T) corresponding to the position and orientation of said housing cavities (36), said trajectories of movement (T) of pins (32d, 32e) being straight and lying on a single plane (V-V) arranged transverse to said longitudinal development direction (P), preferably said trajectories of movement (T) of the pins (32d, 32e) being arranged in diametrically positions opposite with respect to said axis (X).

27. Lock (1) according to claim 26, wherein pins (32d, 32e) have respective lengths (L1, L2) which differ at least by a predetermined distance (d) between said rotation axis (X) of said rotatable shaped element (32a) and said longitudinal development direction (P) of said block (30).

28. Lock (1) according to claim 26, wherein at least one of said pins (32d, 32e) is moved along the respective movement path (T) by means of the gravity force acting on the mass of the same pin (32d), and wherein at least the further pin (32e) is moved by an elastic element (37) such as to maintain it normally in a position of engagement with a seat (22) on an inner surface (21) of said containment body (20).

29. Lock (1) according to claim 2, comprising an electronic programming key configured to transfer to said primary electronic storage device said plurality of security codes to be stored.

30. Lock (1) according to claim 29, wherein said electronic programming key is configured to replace, modify or cancel said plurality of security codes stored on said primary electronic storage device of the reversible locking/unlocking means (32) of the block (30) and/or on said electronic storage device (11) of said electronic key (10) engageable in said programmable electronic lock (1).

31. Method for opening or closing an electronic lock (1), comprising the steps of:
providing an electronic lock (1) as defined in claim 1 on a shutter (100) or a door or similar object;
optionally pre-programming an electronic key (10) by means of a key reading/writing device;
inserting in the electronic lock (1) the pre-programmed electronic key (10) in order to place in contact said electronic storage device (11) and said electrical power supply means (12) of the electronic key (10) with said reversible locking/unlocking means (32);
waiting for an attention acoustic and/or luminous signal or other signal type emitted by said electronic key (10) to signal to a user that the conversion has occurred from the first mechanical interference position to the second position of no mechanical interference between the lock (30) and the containment element (20);
rotating in one direction and by a predetermined angle the electronic key (10), which is mechanically/electrically inserted/connected with the block (30) of the electronic lock (1) to open the lock (1) itself.

32. Method for opening or closing an electronic lock (1), comprising the steps of claim 31, and in addition the steps of:
moving said shutter (100) or a door or similar object towards the respective abutment frame;
rotating in a direction opposite to the opening direction and for a given angle the electronic key (10), which is still mechanically/electrically inserted/connected with the block (30) of the electronic lock (1);
extracting said electronic key (10) from the block (30) of the electronic lock (1);
waiting for an attention acoustic and/or luminous signal or other signal type emitted by said electronic key (10) to signal to a user that the conversion has occurred from the second position of no mechanical interference to the first mechanical interference position between the lock (30) and the containment element (20) of the electronic lock (1).
